(19) United States
(12) Patent Application Publication
(10) Pub. No.: US 2023/0417611 A1
(43) Pub. Date: Dec. 28, 2023

(54) SENSOR IN PARTICULAR A TURNING ANGLE OR TORQUE SENSOR WITH A SUPPORT FOR THE STATOR AGAINST ROTATION

(71) Applicant: Hella GmbH & Co. KGaA, Lippstadt (DE)

(72) Inventor: Manfred Bartscht, Salzkotten (DE)

(21) Appl. No.: 18/463,974

(22) Filed: Sep. 8, 2023

Related U.S. Application Data
(63) Continuation of application No. PCT/EP2022/055470, filed on Mar. 3, 2022.

(30) Foreign Application Priority Data
Mar. 11, 2021 (DE) 10 2021 105 913.5

(51) Int. Cl. G01L 3/04

(52) U.S. Cl. CPC G01L 3/04

(57) ABSTRACT

A sensor is provided, in particular a turning angle or torque sensor, with a stator at rest in relation to surroundings and a rotor that can be rotated in relation to the surroundings and the stator. The stator features a support with which the stator is secured against rotation in relation to the surroundings. A printed circuit board is provided, on which an electronic circuit arrangement of the stator is provided. The support is a pin and the electronic circuit arrangement and the pin are at least partially enveloped by a casting compound. One end of the pin protrudes from the casting compound, and the pin is fixed in or on the printed circuit board or in or on the casting compound.

### CROSS REFERENCE

This application claims priority to PCT Application No. PCT/EP2022/055470, filed Mar. 3, 2022, which itself claims priority to German Application No. 10 2021 105913.5, filed Mar. 11, 2021, the entireties of both of which are hereby incorporated by reference.

### FIELD OF THE INVENTION

The invention relates to a sensor, in particular a turning angle or torque sensor, with at least one stator at rest in relation to the surroundings and at least one rotor that can be rotated in relation to the surroundings and the stator, where the stator features a support with which the stator is secured against rotation in relation to the surroundings, and a printed circuit board in which an electronic circuit arrangement of the stator is provided for.

### BACKGROUND OF THE INVENTION

The document DE 10 2012 105 966 A1 discloses a turning angle sensor for determining a relative angle setting in relation to a reference position. This features a housing, at least one rotor, that is mounted on a bearing in the housing such that it can rotate and a printed circuit board with a circuit arrangement comprising electric and/or electronic components and corresponding to the number of rotors one or more stators. The housing is supported by means of a support, called a connecting component in document DE 10 2012 105 966 A1, against rotating in relation to surroundings of the sensor, namely in a groove of a stationary part of a motor vehicle. Under all potential operating conditions, there is support free of play. This is achieved by a plastic spring of the support being supported by a metal spring and both springs balance out tolerances of the groove and/or the support.

The support including the two springs is elaborate in its design. With the exception of the metal spring, the support can be manufactured from plastic as an injection molded part, but assembly is elaborate due to the use of the metal spring.

### BRIEF DESCRIPTION OF THE INVENTION

This is where the present invention comes in.

The present invention is based on the task of finding a simpler design in particular also for a support free of play of the stator of the sensor referred to at the beginning of the document.

According to the invention, this task is solved by the support being a pin or another projecting element and the electronic circuit arrangement and the pin being at least partially enveloped by a casting compound, where one end of the pin or of the other projecting element protrudes from the casting compound and where the pin or the other projecting element is fixed in or on the printed circuit board or in or on the casting compound.

The pin or the other projecting element can be manufactured and fixed to the printed circuit board in a simple manner. The pin or the other projecting element can be fixed to the printed circuit board in the form of a rivet or fixed to the printed circuit board using a snap on fastener. It is also possible for the pin or the other projecting element to be merely inserted into a hole in the printed circuit board and be further affixed by the molding of the casting compound. The pin or the other projecting element can also be fastened only to the casting compound.

The circuit arrangement can be fully or partially enveloped by the casting compound such that no housing to protect the circuit arrangement from the surroundings is required.

The invention provides a simple means to produce very similar inventive sensors that differ merely in the design of the pin or of the other projecting element or in the position at which the pin or the other projecting element protrudes from the casting compound. This makes it possible to produce at little cost sensors that are adapted to various surroundings.

The pin or the other projecting element can at least partially consist of an elastomer, in particular of a thermoplastic elastomer. Preferentially, at least the end of the pin or the other projecting element protruding from the casting compound consists of the thermoplastic elastomer or it features a coating of a thermoplastic elastomer. With one end of the pin or the other projecting element made of an elastomer, it is easily possible to implement a support free of play of the stator in or on the surroundings.

The pin or the other projecting element can also consist of two plastic components, hard base plate and an elastomer end. It is also possible for the otherwise non-elastomer end of the pin or of the other projecting element to bear a cap made of an elastomer such that by doing so the end is provided with elastomer properties.

A base plate fixed in or on the printed circuit board of the pin or the other projecting element can consist of a material that has a thermal expansion coefficient that is identical or similar in comparison to the end of the pin protruding from the casting compound to the casting compound.

Preferentially, the casting compound consists of a thermoset or thermoplastic.

The end of the pin or the other projecting element can protrude from the casting compound in any direction. In order to be able to act as a support, it must only be possible for the end to engage in a recess, a hole, a groove or similar in the surroundings. Preferentially, it is possible for the end of the pin or of the other projecting element to protrude out of the thermoset in a direction of a rotary axis of the rotor or in parallel to the rotary axis. Similarly, it is possible for the end of the pin or of the other projecting element to protrude from the thermoset material in a direction radial to a rotary axis of the rotor.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a top view onto a part of the inventive sensor.

FIG. 2 is a cross-section through the part from FIG. 1.

### DETAILED DESCRIPTION OF THE DRAWINGS

The part of an inventive sensor shown in the Figures comprises a part of a printed circuit board 1. The printed circuit board 1 is a component of a stator of the sensor that also comprises a rotor; none of the latter is shown. The part shown of the printed circuit board 1 is molded into a casting compound 2. A hole is molded into the casting component 2. A pin 3 is fastened in this hole in the form of a rivet. The pin 3 projects from the casting compound 2 in parallel to a rotary axis. In a variant shown in dashed lines, the pin 3 protrudes out of the casting compound 2 in a radial direction.

The sensor can feature a central recess through which a shaft or axle is guided, for example a steering column. The rotor can be fastened to the shaft or the axle. While the stator is fastened in a torque-proof manner on or in the surroundings of the shaft or axle. Rotation of the stator in relation to the surroundings is prevented by the pin 3, which forms a support of the stator against rotation.

Whereas the casting compound 2 consists of a thermoset, the pin 3 is manufactured from a thermoplastic elastomer. The pin 3 can be oversized in relation to a recess in a body in the surroundings of the sensor. If the pin 3 is inserted into the recess in the body, it will sit free of play in the recess. This enables tolerances between the pin 3 and the recess to be compensated for. Thus, the stator has a support free of play against rotation.

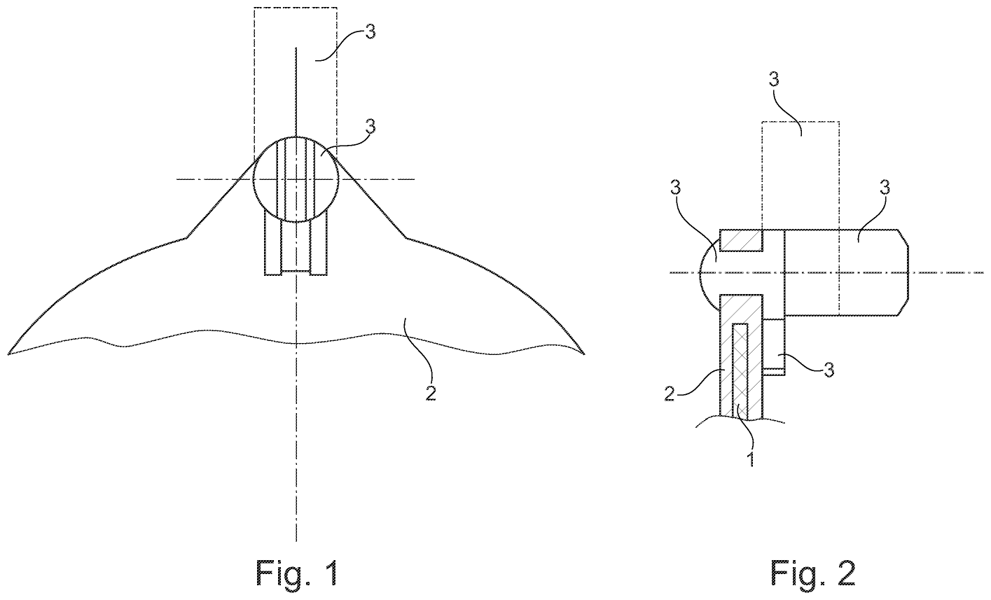

### LIST OF REFERENCE NUMBERS (FIG. 1)

1 Printed circuit board
2 Casting compound
3 Pin

We claim:

1. A sensor comprising:
a stator and a rotor, wherein the stator is at rest and the rotor rotates in relation to the stator, and
a printed circuit board on which an electronic circuit arrangement of the stator is provided for,
a support securing the stator against rotation, wherein the support is a pin or another projecting element,
a casting compound at least partially enveloping the electronic circuit arrangement and the pin or the other projecting element,
wherein one end of the pin or the other projecting element protrudes from the casting compound, and wherein the pin or the other projecting element is fixed in or on the printed circuit board or in or on the casting compound.

2. The sensor in accordance with claim 1, wherein the pin or the other projecting element at least partially includes an elastomer.

3. The sensor in accordance with claim 2, wherein at least an end of the pin or the other projecting element protruding out of the casting compound includes a thermoplastic elastomer, or an end of the pin or the other projecting element includes a coating or an overmolding made of a thermoplastic elastomer.

4. The sensor in accordance with claim 1, wherein the pin or the other projecting element includes two plastic components.

5. The sensor in accordance with claim 4, wherein a base plate fixed in or on the printed circuit board of the pin or the other projecting element includes a material that has a thermal expansion coefficient that is identical or similar in comparison to an end of the pin or the other projecting element protruding from the casting compound to the casting compound.

6. The sensor in accordance with claim 1, wherein the casting compound includes a thermoset or thermoplastic.

7. The sensor in accordance with claim 6, wherein an end of the pin or of the other projecting element protrudes out of the thermoset or thermoplastic in a direction of a rotary axis of the rotor or in parallel to the rotary axis.

8. The sensor in accordance with claim 6, wherein an end of the pin or of the other projecting element protrudes from the thermoset or thermoplastic in a direction radial to a rotary axis of the rotor.
